(19) United States
(12) Patent Application Publication
(10) Pub. No.: US 2019/0032902 A1
(43) Pub. Date: Jan. 31, 2019

(54) ADAPTER BRACKET AND TROFFER MOUNT SYSTEM INCLUDING AN ADAPTER BRACKET

(71) Applicant: LG ELECTRONICS INC., Seoul (KR)

(72) Inventors: Jongki KIM, Seoul (KR); Dalnim JUNG, Seoul (KR); Samje CHO, Seoul (KR)

(21) Appl. No.: 16/048,616

(22) Filed: Jul. 30, 2018

(30) Foreign Application Priority Data
Jul. 28, 2017 (KR) 10-2017-0096431

(51) Int. Cl. F21V 21/04; F21S 8/02

(52) U.S. Cl. CPC F21V 21/04; F21K 9/27; F21S 8/026

(57) ABSTRACT

A troffer mounting system and an adapter bracket may include a first plate provided between a T-bar of a ceiling system and a troffer housing so as to be placed on the T-bar and to extend longitudinally, a second plate connected to a first side of the first plate and having a length smaller than a length of the first plate, the second plate extending upward; two parallel vertical parts or lips connected to a second side of the first plate opposite to the first side, the two lips extending upward; and a third plate connected to a side of the second plate so as to engage with a latch, wherein the two lips do not overlap with or face the second plate in a width direction. Attachment and detachment of a lighting assembly may be easy and convenient, and manufacturing costs of the adapter bracket may be reduced.

### CROSS-REFERENCE TO RELATED APPLICATION(S)

This application claims the priority benefit of Korean Patent Application No. 10-2017-0096431, filed on Jul. 28, 2017 in the Korean Intellectual Property Office, the disclosure of which is incorporated herein by reference.

### BACKGROUND

### 1. Field

An adapter bracket and a troffer mounting system including the adapter bracket used in maintenance and/or installation of an existing troffer-type lighting fixture are disclosed herein.

### 2. Background

Incandescent lamps or fluorescent lamps are commonly used as indoor or outdoor illuminating lamps. Such an incandescent lamp or fluorescent lamp may have a short service life, thereby requiring frequent replacement. In addition, the lighting intensity of a conventional fluorescent lamp may excessively diminish throughout the duration of its operating life. Various types of lighting modules, which adopt a light-emitting diode (LED) capable of realizing excellent controllability, a high response speed, high electricity-to-light conversion efficiency, a long service life, low power consumption, high brightness and pleasant illumination, have been developed to solve these issues.

Recently, existing lighting fixtures attached to troffer housings are being replaced with efficient LEDs. In order to easily install a standardized lighting fixture to a ceiling, a troffer housing may be embedded in the ceiling.

A conventional process of attaching a lighting assembly to a troffer housing may be performed in such a manner as to temporarily fix the lighting assembly to the troffer housing, electrically connect a power supply to the temporarily fixed lighting assembly, and finally embed the lighting assembly in the troffer housing.

Electrical cables of the lighting assembly and the troffer housing may generally be disposed between the rear surface of the lighting assembly and the troffer housing. In order to perform electrical wiring of the lighting assembly and the troffer housing, a worker may hold the lighting assembly at a location near the troffer housing with the aid of an assistant or a subsidiary machine, electrically connect the lighting assembly to the troffer housing, and finally attach the lighting assembly to the troffer housing. Accordingly, there is a need for equipment that enables the lighting assembly to be easily attached and installed to the troffer housing.

### BRIEF DESCRIPTION OF THE DRAWINGS

Embodiments will be described in detail with reference to the following drawings in which like reference numerals refer to like elements, and wherein:

FIG. 1A is a view illustrating a troffer mounting system according to an embodiment;

FIG. 1B is a view illustrating a troffer mounting system according to an embodiment;

FIG. 2 is a view illustrating a troffer housing and two adapter brackets according to an embodiment, which are mounted on a ceiling;

FIG. 3 is an exploded perspective view of a lighting fixture according to an embodiment;

FIG. 4A is an exploded perspective view of the lighting fixture according to an embodiment;

FIG. 4B is an exploded perspective view of the lighting fixture according to another embodiment;

FIG. 5A is a perspective view of an adapter bracket according to an embodiment;

FIG. 5B is a side view of the adapter bracket shown in FIG. 5A;

FIG. 5C is a cross-sectional view of the adapter bracket, which is taken along line A-A of FIG. 5A;

FIG. 5D is a cross-sectional view of the adapter bracket, which is taken along line B-B of FIG. 5A;

FIG. 5E is a perspective view of an adapter bracket showing a set of slots according to an embodiment;

FIG. 5F is a perspective view of an adapter bracket showing a set of slots according to another embodiment;

FIG. 6A is a perspective view of an adapter bracket according to an embodiment;

FIG. 6B is a cross-sectional view of the adapter bracket, which is taken along line C-C of FIG. 6A;

FIG. 7 is a perspective view of an adapter bracket according to an embodiment;

FIG. 8A is a perspective view of an adapter bracket according to an embodiment;

FIG. 8B is a plan view schematically illustrating the adapter bracket shown in FIG. 8A;

FIG. 9A is a perspective view of an adapter bracket according to an embodiment;

FIG. 9B is a plan view schematically illustrating the adapter bracket shown in FIG. 9A;

FIG. 10A is a perspective view of an adapter bracket according to an embodiment;

FIG. 10B is a plan view schematically illustrating the adapter bracket shown in F. 10A;

FIG. 11A is a perspective view of an adapter bracket according to an embodiment; and

FIG. 11B is a plan view schematically illustrating the adapter bracket shown in FIG. 11B.

### DETAILED DESCRIPTION

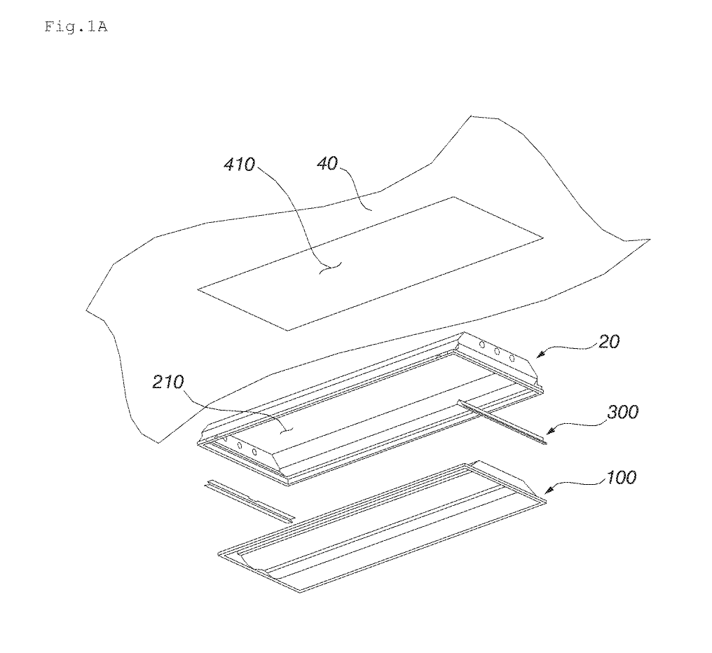

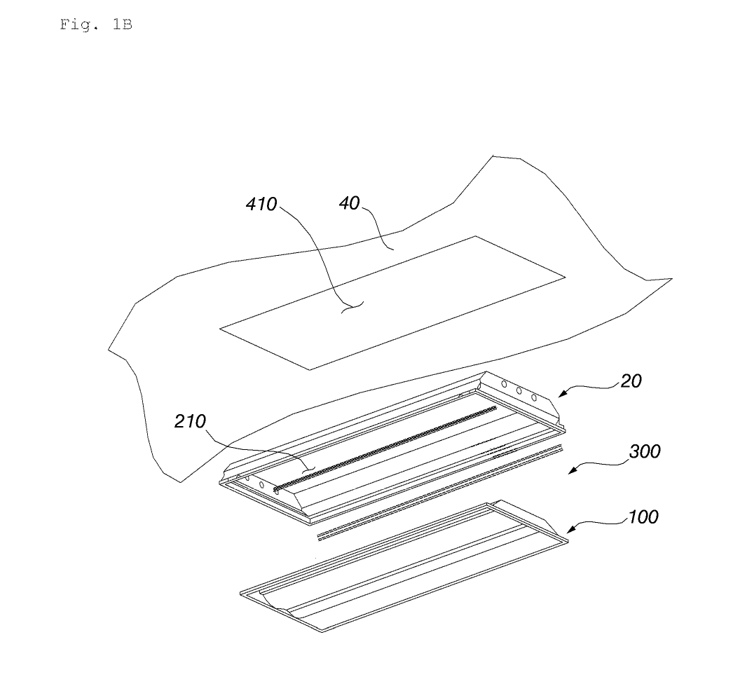

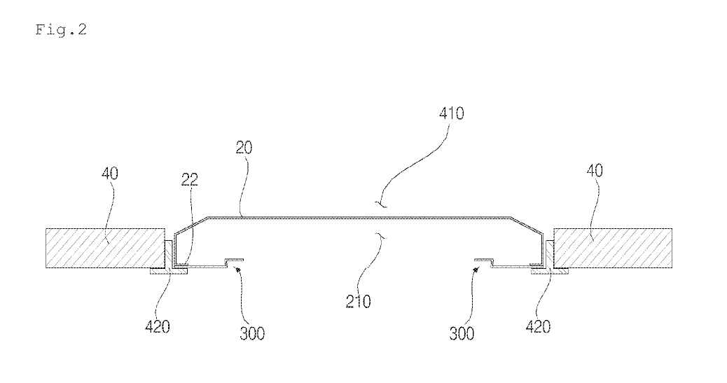

Referring to FIGS. 1A-2, a troffer mounting system according to an embodiment includes a troffer housing 20 and two adapter brackets 300. A troffer mounting system according to another embodiment includes two adapter brackets 300 and a lighting assembly coupled to the two adapter brackets 300.

The troffer mounting system may be used in maintenance, replacement and/or installation of a lighting fixture or lighting assembly in an existing troffer housing 20. The troffer housing 20 may be installed in a home, an office, a plant, etc. so as to allow a lighting assembly 100 to be easily coupled to the troffer housing 20 and to provide a space that accommodates the lighting assembly 100. The troffer housing 20 may be connected to an external power source so as to supply power to the lighting assembly 100.

For example, the troffer housing 20 may have an opening 210 in which the lighting assembly 100 may be provided and which may open in a first direction. Specifically, the troffer housing 20 may have a rectangular shape. The opening 210 in the troffer housing 20 may be provided at an edge thereof and may include a flange 22, which extends inwardly or outwardly.

The troffer housing 20 may be embedded and secured in a hole 410 formed in a ceiling 40. T-bars 420 may be provided at opposite sides of the hole 410 formed in the ceiling 40 to facilitate installation of the troffer housing 20 in the ceiling 40. The troffer housing 20 may be supported by inner sides of the T-bars 420.

The adapter brackets 300 may enable opposite sides of the lighting assembly to be provided in the troffer housing 20, thereby improving convenience in a user's electrical wiring work. The adapter brackets 300 may be fastened or coupled to a part of the lighting assembly so as to secure the lighting assembly to the troffer housing 20.

The adapter brackets 300 may be provided on the T-bars 420. A part of the adapter bracket 300 may be provided between the T-bar 420 and the troffer housing 20. The other part of the adapter bracket 300 may extend toward the inside of the troffer housing 20, thereby providing a support to which the lighting assembly may be coupled.

There may be at least two adapter brackets 300, which may be opposite to each other. The adapter brackets 300 may be provided at opposite sides of the hole 410, where the T-bars 420 may be provided.

The lighting assembly 100 may include various constructions and configurations to cover the opening 210 of the troffer housing 20. For example, the lighting assembly 100 may include a lighting device that emits light, a cover that covers a light source mounted in the troffer housing 20, and a lens. In this example, the lighting assembly 100 may include a light source and a lens.

The adapter brackets may be configured to be places under a longitudinal or lengthwise side of the troffer housing 20, as shown in FIG. 1A, or may be configured to be placed under a lateral or widthwise side of the troffer housing, as shown in FIG. 1B.

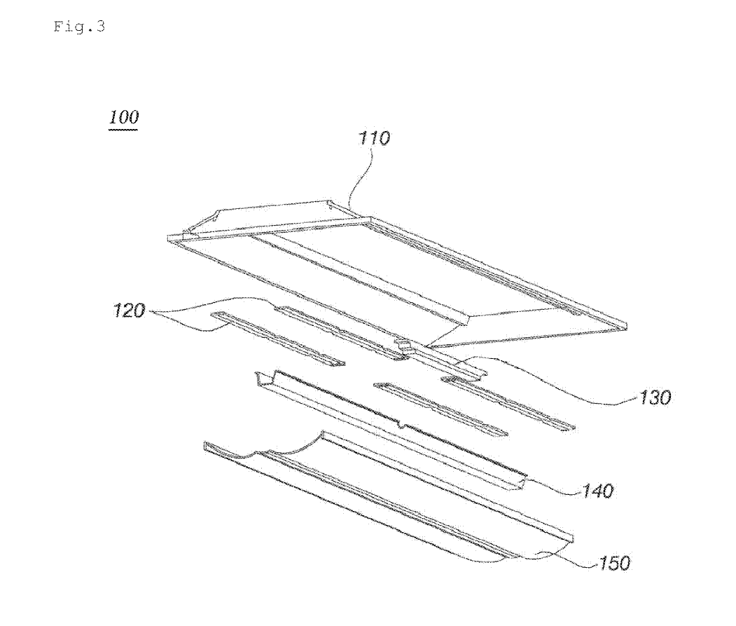

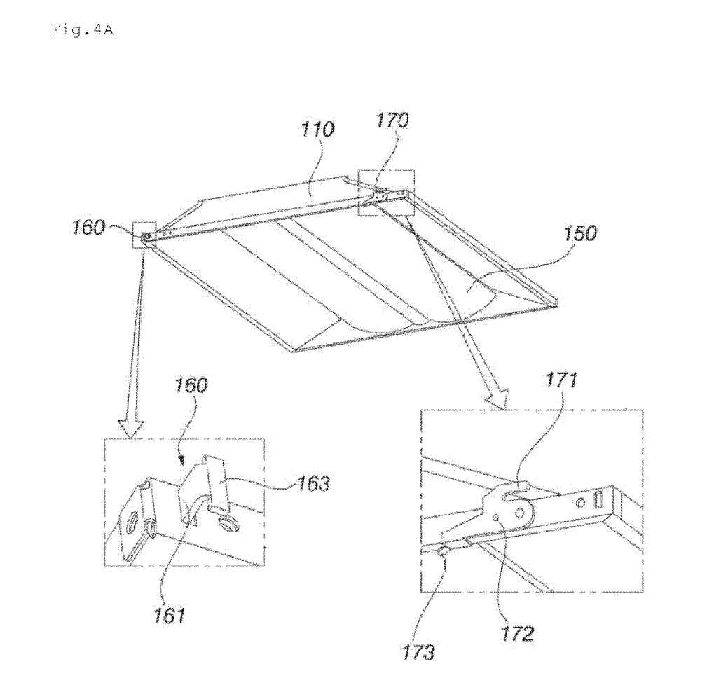

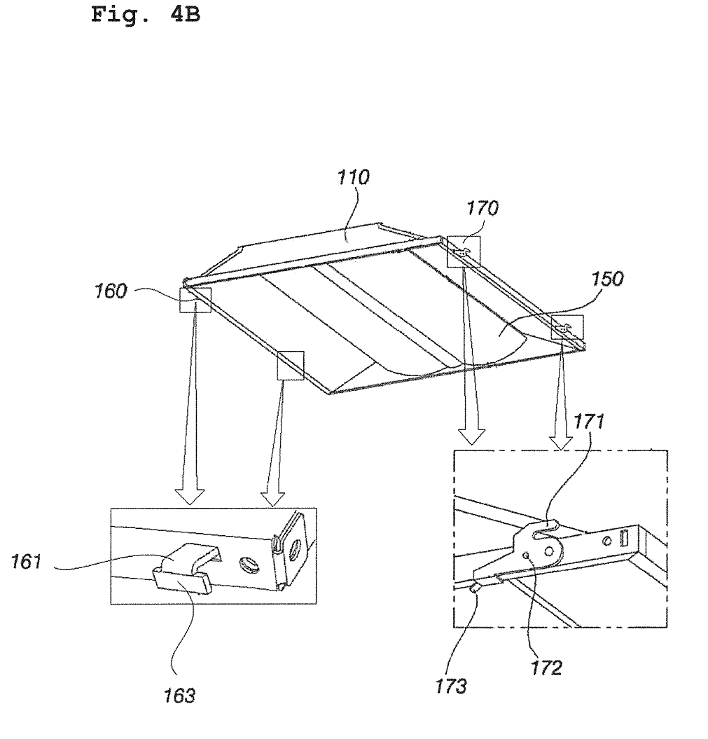

Referring to FIGS. 3-4B, the lighting assembly 100 may convert electric energy into light energy and generating light. In other words, the lighting assembly 100 may electrically produce or emit light radiation. For example, the lighting assembly 100 may include at least one light source 120 and a case 110 in which the at least one light source 120 is provided.

The case 110 may be accommodated in the opening 210 in the troffer housing 20. Accordingly, the case 110 may have a shape corresponding to the shape of the troffer housing 20. The case 110 may be partially exposed downward from the troffer housing 20. For example, the case 110 may have a shape capable of guiding light emitted from the light sources 120 downward. The case 110 may be open at a lower face thereof and may increase in width with increasing distance downward from an upper end thereof. An inner surface of the case 110 may be coated with at least one of Al, Ag, an Al alloy, and an Ag alloy.

The at least one light source 120 may convert electrical energy into light energy; that is, the at least one light source 120 may use electricity to emit light. The at least one light source 120 may include at least one of an incandescent lamp, a halogen lamp, and/or a light-emitting element. For example, the at least one light source 120 may include at least one light-emitting element having excellent energy efficiency, and may be divided into a plurality of groups of light-emitting elements. The at least one light-emitting element may be a light-emitting diode chip capable of emitting one of red light, green light, and/or blue light. The at least one light source 120 may be constituted by a circuit board extending in one direction with the plurality of light-emitting elements mounted on the circuit board.

The at least one light source 120 may be provided on a first surface of the case 110, and the light emitted from the at least one light source 120 may be guided downward by the case 110. A power supply may be provided on a surface of the case 110. The power supply 130 may supply electric current to individual components, elements, are features constituting the lighting assembly 100.

For example, the power supply 130 may receive alternating current of 110 V-220 V and may supply one of direct current of 25 V, 50 V and 100 V as a result of current conversion from the received alternating current. In addition, the power supply 130 may supply direct current of 3 V to a communication module after converting the received alternating current.

The power supply 130 may be positioned near the at least one light source 120 or between the plurality of light sources 120, which may be arranged in multiple columns. The power supply 130 may be covered by a power supply cover 140. The power supply cover 140 may prevent the light generated from the at least one light source 120 from being absorbed by the power supply 130.

The power supply cover 140 may be positioned between the plurality of light sources 120 so as to guide the light generated from the light sources 120 downward. An outer surface of the power supply cover 140 may be coated with reflective material.

The lighting assembly 100 may further include a diffusion cover 150 that diffuses the light supplied from the at least one light source 120. The diffusion cover 150 may alleviate the concentration of the light generated from the at least one light source 120. The diffusion cover 150 may cover a predetermined area under the case 110 so as to cover at least the at least one light source 120. For example, the diffusion cover 150 may have an uneven surface that diffuses light, or may include a diffusive material that scatters or reflects light inward, but is not limited thereto.

The lighting assembly 100 may be provided with a connection member or fastener that fastens or couples the lighting assembly 100 to the adapter bracket 300. Alternatively, a portion of the lighting assembly 100 may also be directly fastened or coupled to the adapter bracket 300.

The fastener of the lighting assembly 100 may include a hanger 160 and/or a latch 170. The lighting assembly 100 may be hanged on the adapter bracket 300 via the hanger 160. The hanger 160 may be fitted into a slot 321 in the adapter bracket 300. The hanger 160 may include two to four hangers, which may be provided at opposite ends of the case 110 corresponding to the adapter brackets 300.

The hanger 160 may include a fitting member 161 and a constriction member 163. The hanging member 161 may extend from an outer surface of the case 110 and may be fitted into the slot 321 in the adapter bracket 300.

The constriction member 163 may prevent a separation or decoupling of the fitting member 161 from the adapter bracket 300. The constriction member 163 may extend from the fitting member 161 and may have a size (width or height) larger than the fitting member 161.

The fastener may alternatively be or additionally include the latch 170. The latch 170 may be coupled to the lighting assembly 100, and may be detachably coupled to the adapter bracket 300. The latch 170 may be rotatably coupled to the case 110. Accordingly, the latch 170 may be fitted into or removed from the slot 321 in the adapter bracket 300 by rotating the same.

For example, the latch 170 may include a fitting piece or hook 171, a hinge 172 and a lever 173. The hook 171 may engage with the slot 321 in the adapter bracket 300 and may have a hook shape. The hinge 172 may enable the hook 171 to be rotatably coupled to the case 110. The hinge 172 may be a rotating shaft of the latch 170. When external force is applied to the lever 173, the hook 171 may be rotated.

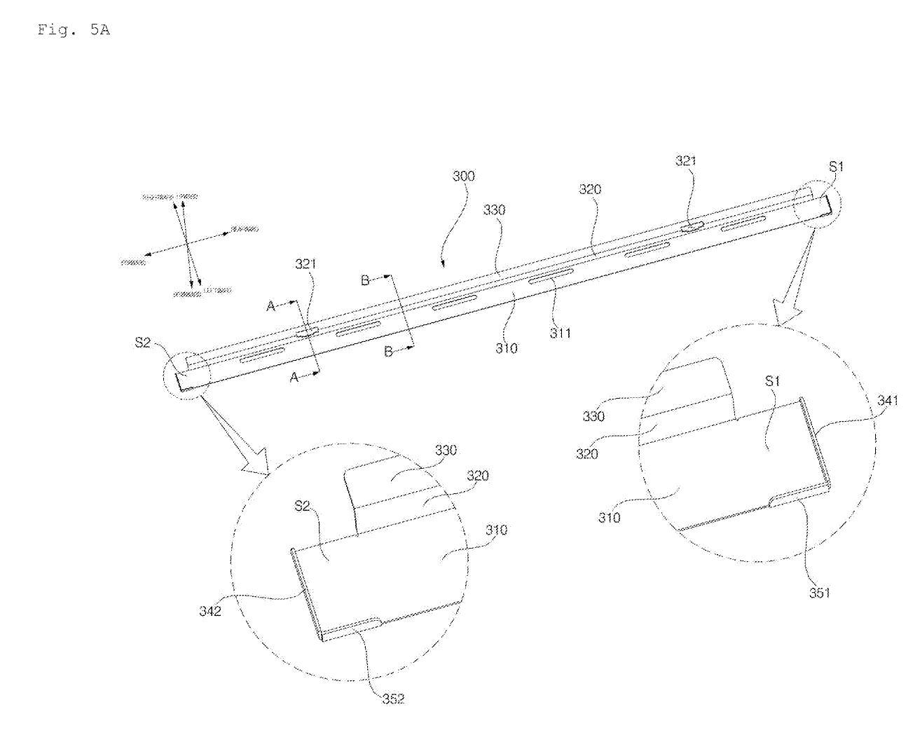

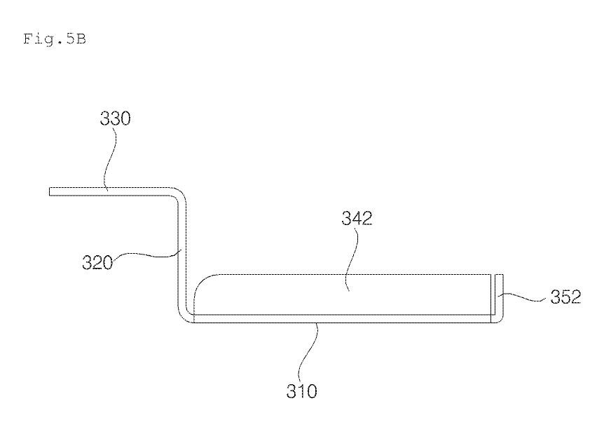

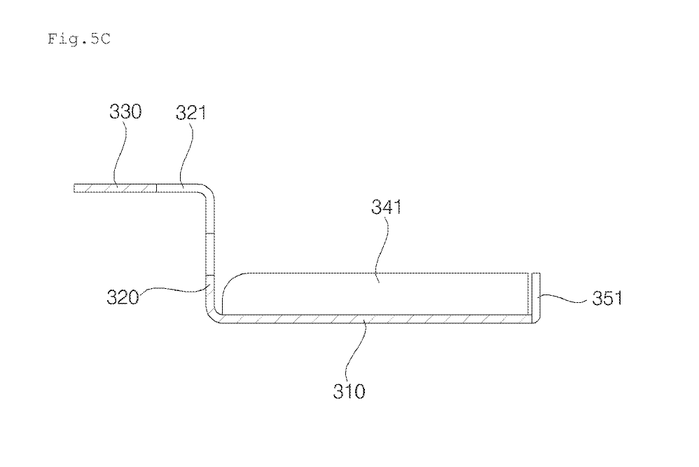

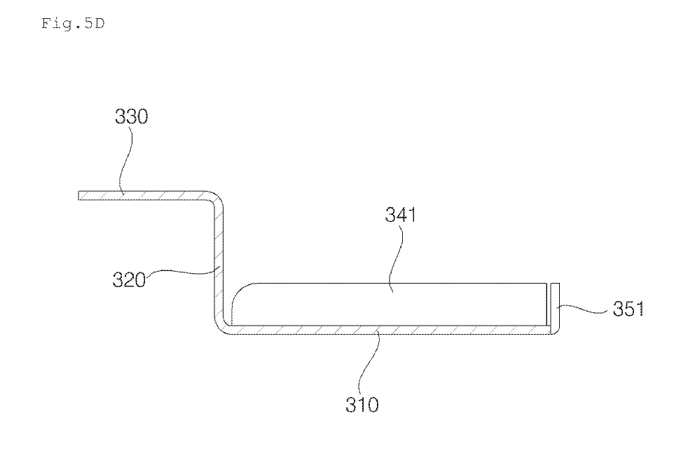

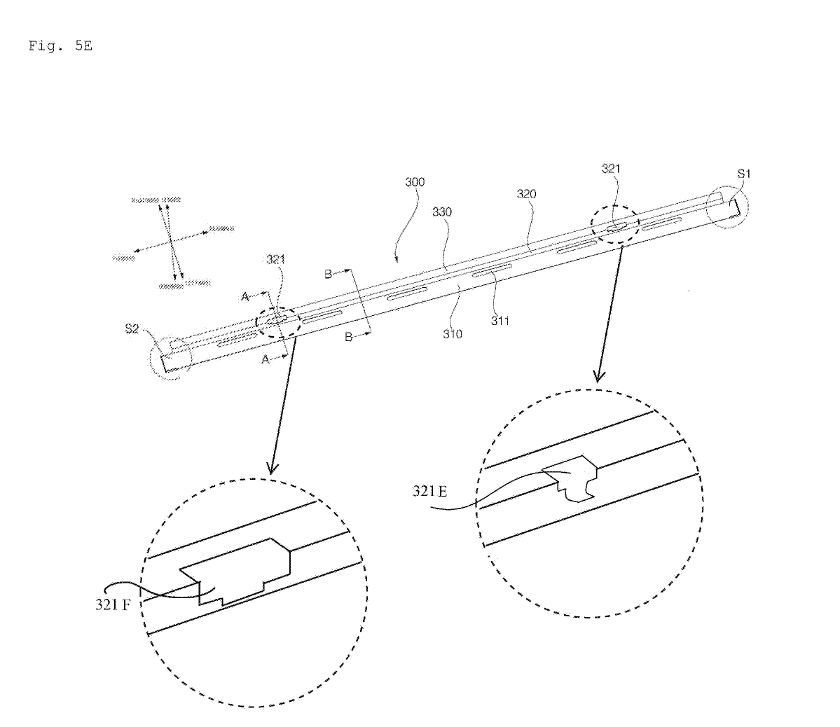

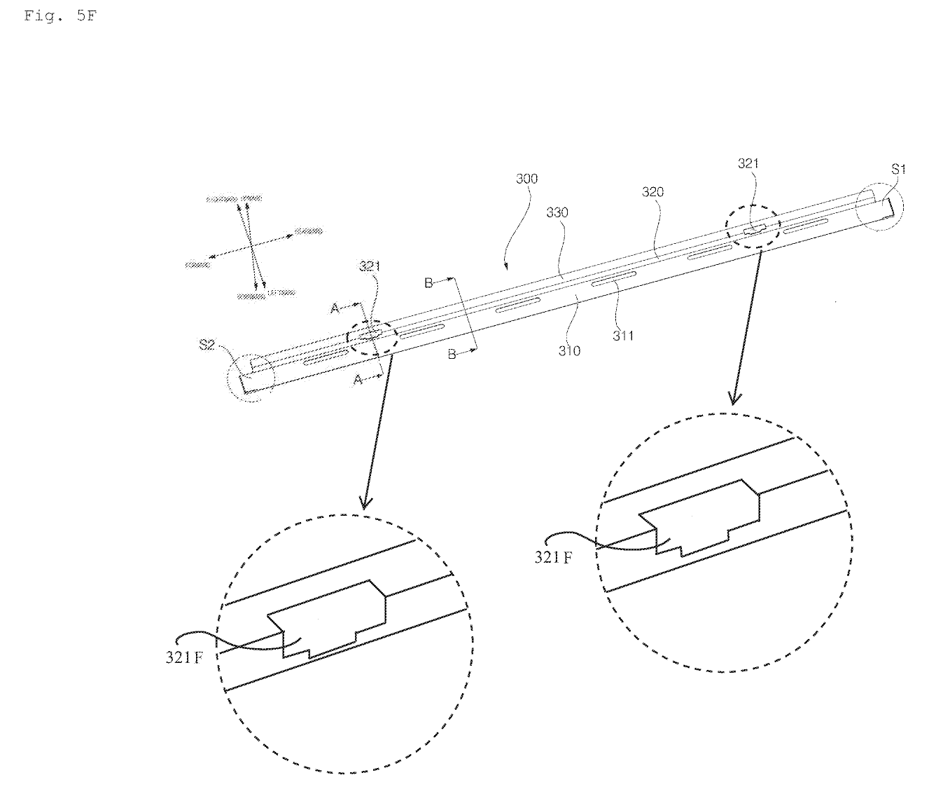

As an example, a plurality of hangers 160 may be provided on a first side of the case 110, while a plurality of latches 170 may be provided on a second side of the case 110 that is opposite to the first side of the case 110. In this exemplary embodiment, the first side of the case 110 may be configured to engage with a slot 321F that accommodates the hanger 160 in a first adapter bracket in a set of adapter brackets, and the second side of the case 110 may be configured to engage with a slot 321F that accommodates the latch 170 in a second adapter bracket. In this exemplary embodiment, the adapter brackets 300 may be arranged longitudinally, as shown in FIG. 1B, the plurality of hangers 160 and the plurality of latches 170 may be arranged as shown in FIG. 4B, and the slots 321F may be identical and may have a shape as shown in FIG. 5F.

As another example, the hanger 160 and the latch 170 may be provided on opposite ends of the same side of the case 110, and the latch may engage with slot 321F while the hanger engages with slot 321E in an adapter bracket 300 that engages with a widthwise or lateral side of the troffer housing 20 and the lighting assembly 100, as shown in FIG. 1A and FIG. 5E. The hanger 160 and the latch 170 may be arranged as shown in FIG. 4A, and the slots 321 may have a different shape. Slot 321F may have the same or a similar shape to the slots 321F shown in FIG. 5F.

A process of installing the lighting assembly 100 to the troffer housing 20 may be performed to temporarily fix the lighting assembly 100 to the troffer housing 20, to electrically connect the temporarily fixed lighting assembly 100 to the troffer housing 20, and to embed the lighting assembly 100 in the troffer housing 20.

Electrical cables of the lighting assembly 100 and the troffer housing 20 may generally be hidden between a back surface of the lighting assembly 100 and the troffer housing 20. Accordingly, in order to attach the lighting assembly 100 to the troffer housing 20, a worker may hold the lighting assembly 100 at a location near the troffer housing 20 with the aid of an assistant or a subsidiary machine, electrically connect the lighting assembly 100 to the troffer housing 20, and finally attach the lighting assembly 100 to the troffer housing 20. There is a disadvantage in this particular installation method in that it may not be easy to temporarily fix the lighting assembly 100 to the troffer housing 20, and it may be difficult to remove the lighting assembly 100 from the troffer housing 20 and attach a new lighting assembly 100 to the troffer housing 20.

In order to solve the above-described disadvantage, the embodiments disclosed herein may enable the lighting assembly 100 to be detachably attached to the troffer housing 20 and/or the adapter brackets 300, thereby enabling one end of the lighting assembly 100 to be supported by the troffer housing 20 in a servicing operation.

The adapter bracket 300 according to an embodiment may have any configuration. The adapter bracket 300 according to an embodiment may be provided between the T-bar 420 and the troffer housing 20, while the remaining part of the adapter bracket 300 may extend inward so as to provide a region to which the lighting assembly 100 is coupled.

For example, an adapter bracket 300 according to an embodiment includes a horizontal part or a first plate 310, a side part or a second plate 320, parallel vertical parts or first and second lips 351 and 352 and a latch part, a second horizontal part, or a third plate 330. The adapter bracket 300 may further include parallel vertical parts, or first and second lips 351 and 352. The first and second lips may extend from the first plate at opposite ends of the first plate 310. An adapter bracket 300 according to another embodiment may include a horizontal part or a first plate 310, a side part or a second plate 320, and parallel vertical parts or first and second lips 351 and 352. An adapter bracket 300 according to still another embodiment may include a horizontal part or first plate 310, a side part or second plate 320, parallel vertical parts or first and second lips 351 and 352, a latch part or a third plate 330, and cross vertical parts or third and fourth lips 341 and 342. The third and fourth lips may extend from the first plate at opposite ends of the first plate 310. An adapter bracket 300 according to yet another embodiment includes a horizontal part or a first plate 310, a side part or a second plate 320, parallel vertical parts or first and second lips 351 and 352, a latch part or a third plate 330, and a slot 321 configured to receive a hanger 160 or a latch 170 of a lighting assembly 100. An adapter bracket 300 according to a further embodiment includes a horizontal part or a first plate 310, a side part or a second plate 320, parallel vertical parts or first and second lips 351 and 352, a latch part or a third plate 330, and a segregation slot, a segregation space, or a notch 312 dividing the first plate 310 into two segments.

Hereinafter, the adapter brackets 300 according to these several exemplary embodiments will be described. Referring to FIGS. 5A to 5F, an adapter bracket 300 according to an embodiment may include a horizontal part or first plate 310, a side part or a second plate 320, parallel vertical parts or first and second lips 351 and 352, and a latch part or a third plate 330.

The first plate 310 may be placed on a T-bar 420 and may be provided between a T-bar 420 and a troffer housing 20. A flange 22 of the troffer housing 20 may be provided on an upper or top surface of the first plate 310, whereas a lower or bottom surface of the first plate 310 may be provided on the T-bar 420. The first plate 310 may have a predetermined width, and may extend in a longitudinal direction of the adapter bracket 300 (in the anteroposterior direction in FIG. 5A).

The first plate 310 may be provided with at least one air vent hole, vent, or opening 311 that discharges heat from the lighting assembly 100 to the outside. The openings 311 may be formed by cutting several portions of the first plate 310. The openings 311 may include a plurality of air vent holes, vents, or openings, which may be arranged longitudinally at predetermined intervals. The openings 311 may be provided on a first side of the first plate 310 that does not contact the flange 22 of the troffer housing 20 or the T-bar 420 such that a flow of the discharged air is not blocked. The openings 311 may be also be provided such that they do contact the flange 22 of the troffer housing 20.

The second plate 320 may be connected to the first side of the first plate 310. Here, the first side of the first plate 310 refers to one of the opposite sides in the width direction (in the lateral direction). In this embodiment and in reference to FIG. 5A, the first side of the first plate 310 refers to the rightward edge of the first plate 310.

The second plate 320 may be defined as a part intersecting the first plate 310. The second plate 320 may intersect the first plate 310 at about 90 degrees such that the second plate 320 is perpendicular to the first plate 310. The second plate 320 may extend from the first plate 310 in a vertical direction, or upward from the first side of the first plate 310. The second plate 320 may extend in a longitudinal direction of the adapter bracket 300. The second plate 320 may have a length shorter than that of the first plate 310.

Opposite ends of the first plate 310 in the longitudinal direction may project outward from opposite ends of the second plate 320 in the longitudinal direction such that there is a portion or section of the first plate 310 that is not connected to the second plate 320. Accordingly, predetermined regions of the opposite ends of the first plate 310 may be defined as non-overlapping regions S1 and S2, which do not overlap the second plate 320 in the lateral direction. That is, there is no part of the second plate that may extend from the first plate in the non-overlapping regions S1 and S2.

The third plate 330 may be constructed so as to be engaged with the latch 170 or hanger 160 of the lighting assembly 100. The third plate 330 may be connected to first side or a top side of the second plate 320. The third plate 330 may be connected to a side of the second plate 320 that is opposite the side connected to the first plate 310. In other words, a lower end of the second plate 320 may be connected to the first plate 310, and the opposite end, or an upper end, of the second plate 320 may be connected to the third plate 330.

The third plate 330 may be defined as a part intersecting the second plate 320. Although there is no limitation as to the angle defined between the third plate 330 and the second 320, the angle may be set to be about 90 degrees such that the third plate extends perpendicularly from the second plate.

The third plate 330 may extend from the upper end of the second plate 320 in the lateral direction. The third plate 330 may be positioned so as not to correspond to or be aligned with the first plate 310. The third plate 330 may be positioned to be parallel to the first plate 310 with a height difference therebetween. The height difference may be equal to the height of the second plate. The third plate 330 may extend from the upper end of the second plate 320 rightward or in a lateral direction. The third plate 330 may have a length corresponding to the length of the second plate 320. The third plate 330 may have a length that is less than the length of the first plate 310 such that it does not overlap with the first plate in the regions S1 and S2, or may have a length that is longer than the length of the first plate 310 such that it extends beyond the length of the second plate 320 into the regions S1 and S2.

The third plate 330 may further be provided with slots 321 into which portions of the lighting assembly 100 are fitted. The slots 321 may receive the hanger 160 or the latch 170 of the lighting assembly 100. The slots 321 may receive portions of the lighting assembly 100 so as to couple the lighting assembly to the adapter bracket 300.

In an example, the slots 321 may be holes formed in the third plate 330 so as to be engaged with the hangers 160 and/or the latches 170 of the lighting assembly 100. The slots 321 may be positioned so as to not be aligned with the openings 311 in order to maintain the rigidity of the adapter bracket 300.

In another example, the slots 321 may be located between the third plate 330 and the second plate 320 so as to be formed in both the third plate 330 and the second plate 320. The slot 321 may be defined as a hole formed in both a portion of the third plate 330 and a portion of the second plate 320. In the case where the slot 321 is formed in both a portion of the third plate 330 and a portion of the second plate 320, the installation of the lighting assembly 100 may be performed in such a manner that the hangers 160 are fitted into the slots 321 formed in the second plate 320 by a worker such that one end of the lighting assembly 100 is supported by the second plate 320, and the hangers 160 are also engaged with the slots 321 formed in the third plate 330 after electrical wiring work. Accordingly, the worker's convenience in installation of the lighting assembly 100 may be improved.

The parallel vertical parts or the first and second lips 351 and 352 may include two parallel vertical parts or two parallel plates. The first and second lips may extend from the first plate 310. A space that accommodates a portion of the troffer housing 20 may be defined between the first and second lips 351 and 352 and the second plate 320. The first and second lips 351 and 352 may define a space that accommodates or constricts a portion of the troffer housing 20 together with the first plate 310 and the second plate 320. The first and second lips 351 and 352 may be positioned so as not to overlap the second plate 320.

The first and second lips 351 and 352 may be connected to a second side of the first plate 310, which is opposite the first side of the first plate 310. Here, the second side of the first plate 310 refers to one of opposite sides of the first plate 310 in the width direction (in the lateral direction). In FIG. 5A, the second side of the first plate 310 refers to the leftward side of the first plate 310.

The first and second lips 351 and 352 may be defined as parts intersecting the first plate 310. The first and second lips 351 and 352 may intersect the first plate 310 at about 90 degrees. The first and second lips 351 and 352 may extend upward from the second side of the first plate 310.

The first and second lips 351 and 352 may be disposed so as not to overlap the second plate 320 in the width direction. The first and second lips 351 and 352 may extend upward in the two non-overlapping regions S1 and S2 in opposite longitudinal ends of the first plate 310, which do not overlap the second plate 320 in the lateral direction.

A length of the first and second lips 351 and 352 may be smaller than or equal to a length of the non-overlapping regions S1 and S2, and a height of the first and second lips 351 and 352 may be smaller than a height of the second plate 320. In other words, the first and second lips 351 and 352 may be positioned such that they do not face the second plate 320, and are instead opposite to an opening that may be part of an opening 210 in the troffer housing 20.

The first lip 351 may be positioned at a first longitudinal end of the first plate 310, and the second lip 352 may be positioned at a second longitudinal end of the first plate 310. The first lip 351 and the second lip 352 may be positioned so as to be parallel to each other. The first lip 351 and the second lip 352 may be positioned so as to be parallel to, but not facing, the second plate 320. The first lip 351 and the second lip 352 may be spaced apart from each other in the longitudinal direction, and may be aligned with each other in the longitudinal direction. That is, the first lip 351 and the second lip 352 may be spaced apart from each other by a distance that is greater than or equal to a length of an inner region of the first plate 310 from which the second plate 320 extends. A space between the first lip 351 and the second lip 352 may therefore have a length that is greater than or equal to a length of the second plate 320 in a longitudinal direction. The first lip 351 and the second lip 352 may not be aligned with each other in the width direction. The first lip 351 and the second lip 352 may extend at different angles from the first plate 310, or they may extend at the same angle from the first plate 310, but may not exactly be aligned in the width direction due to variations in the width in the first plate

The first lip 351 may extend upward from a second side of the first non-overlapping region S1 of the first plate 310. The length of the first lip 351 may be less than or equal to the length of the first non-overlapping region S1. The height of the first lip 351 may be less than the height of the second plate 320. Since the two lips 351 and 352 may be connected to partial regions of the first plate 310 without overlapping or facing the second plate 320, manufacturing costs may be reduced while a portion of the troffer housing 20 may be secured and accommodated in a stable manner.

The adapter bracket 300 according to an embodiment may further include third and fourth lips 341 and 342 to further accommodate and constrict the troffer housing 20 between the first and second lips 351 and 352 and the second plate 320. The third and fourth lips 341 and 342, together with the first and second lips 351 and 352, may define a space that accommodates a portion of the troffer housing 20. The second plate 320 may further define a space that accommodates a portion of the troffer housing 20. The third and fourth lips 341 and 342 may define a space that accommodates and/or constricts a portion of the troffer housing 20, together with first and second lips 351 and 352, the first plate 310, and the second plate 320, without overlapping the second plate 320 and/or the first and second lips 351 and 352.

The third and fourth lips 341 and 342 may be connected to opposite longitudinal ends of the first plate 310. The third and fourth lips 341 and 342 may be defined as parts intersecting the first plate 310. The third and fourth lips 341 and 342 may be angled about 90 degrees with respect to the first plate 310 such that the third and fourth lips 341 and 342 extend perpendicularly from the first plate 310. The third and fourth lips 341 and 342 may extend from opposite longitudinal ends of the first plate 310. The third and fourth lips 341 and 342 may define an angle of about 90 degrees with respect to the first and second lips 351 and 352, and the second plate 320.

The third and fourth lips 341 and 342 may be positioned so as not to overlap the second plate 320 in the width direction. The third and fourth lips 341 and 342 may extend from the two non-overlapping regions S1 and S2 of the opposite longitudinal ends of the first plate 310, which do not overlap the second plate 320 in the width direction. The third and fourth lips 341 and 342 may also be positioned so as to not overlap with the first and second lips 351 and 352 in the width direction and in the longitudinal direction.

The third and fourth lips 341 and 342 may be connected to or spaced apart from the first and second lips 351 and 352, which may be positioned adjacent or in close proximity thereto. The third and fourth lips 341 and 342 may have a length less than or equal to that of the first plate 310, and the third and fourth lips 341 and 342 may have a height less than that of the second plate 320. The third and fourth lips 341 and 342 may further have a length less than or equal to a width of the first plate 310. The third and fourth lips 341 may have curved upper corners such that a top length of the third and fourth lips 341 and 342 may be equal to or slightly greater than a width of the first plate 310, or such that sides of the third and fourth lips 341 and 342 connect with sides of the first and second lips 351 and 352.

The third and fourth lips 341 and 342 may be positioned with or without being aligned with each other in the longitudinal direction depending on the length and position thereof. FIGS. 5A-5D illustrate an embodiment in which the third and fourth lips 341 and 342 may have the same length as the width of the first plate 310, and are aligned with each other in the longitudinal direction.

The third lip 341 may be connected to a first longitudinal end of the first plate 310, and the fourth lip 342 may be connected to a second longitudinal end of the first plate 310. The third and fourth lips 341 and 342 may be positioned so as to be opposite each other. The third and fourth lips 341 and 342 may be positioned so as to be spaced apart from each other in the longitudinal direction, and may be positioned so as to be aligned with each other in the longitudinal direction without being aligned with each other in the width direction. That is, the third and fourth lips 341 and 342 may be parallel to each other, but may not necessarily face each other.

The third lip 341 may extend upward from one end of the first non-overlapping region S1 of the first plate 310. The third lip 341 may have a length smaller than or equal to a width of the first non-overlapping region S1 or the width of the first plate 310. The third lip 341 may have a height smaller than that of the second plate 320.

The fourth lip 342 may extend upward from one end of the second non-overlapping region S2 of the first plate 310. The fourth lip 342 may have a length smaller than or equal to a width of the second non-overlapping region S2 or the width of the first plate 310. The fourth lip 342 may have a height smaller than that of the second plate 320. Since the third and fourth lips 341 and 342 may be connected to partial regions of the first plate 310 without overlapping or contacting the second plate 320, manufacturing costs may be reduced and a portion of the troffer housing 20 may be secured and accommodated in a stable manner.

Although the drawings illustrate the respective third and fourth lips 341 and 342 as being integrally formed, each of the third and fourth lips 341 and 342 may be constructed as a plurality of segments that are arranged at a regular pitch.

The first plate 310 of the adapter bracket may have a length in the range of 120-125 cm; for example, the length of the first plate 310 may be 121.80 cm±0.05 cm. A width of the first plate 310 may be in the range of 3-4 cm; for example, the width of the first plate 310 may be 3.75±0.01 cm.

The second plate or side part 320 may have a length in the range of 115-120 cm; for example, the length of the second plate 320 may be 116.88±0.03 cm. The second plate 320 may have a height in the range of 1-2 cm; for example, the height of the second plate 320 may be 1.55±0.04 cm.

The third plate 330 may have a length that is greater than lengths of the first plate 310 and the second plate 320, a length that is greater than that of the second plate 320 but less than the first plate 310, or a length that is less than the lengths of the first plate 310 and the second plate 320. As an example, the third plate 330 may have a length in the range of 115-120 cm; for example, the third plate 330 may have a length of 116.83±0.03 cm. However, the third plate 330 may extend beyond the range of 115-120 cm, or may be shorter than that range. The third plate 330 may have a width in the range of 1-2 cm, for example, but may extend beyond that range or may be less than that range. As an example, the third plate 330 may have a width of 1.69±0.01 cm.

The first and second lips 351 and 352 may have a length in the range of 2.0-2.5 cm; for example, the first and second lips 351 and 352 may each have a length of 2.17±0.02 cm, or they each may have different lengths. The first and second lips 351 and 352 may have a height in the range of 0.6-0.7 cm; for example, the first and second lips may each have a length of 0.65±0.02 cm, or they each may have different heights.

The third and fourth lips may have a length in the range of 3.5-3.8 cm; for example, the third and fourth lips may each have a length of 3.67±0.01 cm, or they each may have different lengths. The third and fourth lips 341 and 342 may have a height in the range of 0.6 cm-0.7 cm; for example, the third and fourth lips 341 and 342 may each have a height of 0.63±0.01 cm, or they may each have different heights. The heights of the third and fourth lips 341 and 342 may be greater than, equal to, or less than the heights of the first and second lips 341 and 342, or any combination thereof. For example, the height of the first lip may be greater than a height of the third lip, while the height of the second lip may be less than a height of the fourth lip.

The sum of the length of the non-overlapping regions, S1 and S2, may be equal to a difference between the length of the first plate 310 and the length of the second plate 320. The lengths of regions S1 and S2 may fall in the range of 2-5 cm; for example, the lengths of regions S1 and S2 may each be 2.33±0.04 cm; or, a sum of the lengths of regions S1 and S2 may be 4.66±0.04 cm. The length of region S1 may be equal to or unequal to the length of region S2.

The at least one opening 311 may have a length in the range of 8-9 cm; for example, the at least one opening may have a length of 8.26±0.02 cm. The at least one opening may have a width in the range of 0.5-1.0 cm; for example, the at least one opening may have a width of 0.77±0.01 cm.

The lengths, widths, and heights of the first plate 310, second plate 320, third plate 330, first and second lips 351 and 352, third and fourth lips 341 and 342, and openings 311 are not limited to the exemplary measurements disclosed herein. These length, width, and height approximations may be used for an adapter bracket 300 that is configured to engage with a longitudinal side of the troffer housing 20, like the adapter brackets 300 shown in FIG. 1B and 4B.

The width of the first plate 310 may be significantly less than the length of the first plate 310. A ratio of the width of the first plate 310 to the length of the first plate 310 may be in the range of 0.02-0.05; for example, 0.031±0.001.

The length of the second plate 320 may be less than the length of the first plate 310. A ratio of the length of the second plate 320 to the length of the first plate 310 may be in the range of 0.80-0.98; for example, a ratio of the length of the second plate 320 to the length of the first plate may be 0.960±0.001. The height of the second plate 320 may be significantly less than the length of the second plate 3320. A ratio of the height of the second plate 320 to the length of the second plate 320 may fall in the range of 0.01-0.03; for example, 0.013±0.001. The width of the third plate 330 may be less than the length of the third plate 330. A ratio of the width of the third plate 330 to the length of the third plate 330 may be, for example, 0.014±0.001.

The length of the first and second lips 351 and 352 may be significantly less than a length of the first plate 310. A ratio of the length of the first and second lips 351 and 352 to the length of the first plate 310 may be in the range of 0.01-0.03; for example, 0.018±0.001. The height of the first and second lips 351 and 352 may be less than a height of the second plate 320. A ratio of the height of the first and second lips 351 and 352 to the height of the second plate 320 may be in the range of 0.3-0.5; for example, 0.416±0.016.

The lengths of the third and fourth lips 341 and 342 may be roughly the same size as, or less than, a width of the first plate 310. A ratio of the length of the third and fourth lips 341 and 342 may fall in the range of 0.95-1.00; for example, 0.980±0.003. The lengths of the third and fourth lips 341 and 342 may be significantly less than the length of the first plate 310. A ratio of the lengths of the third and fourth lips 341 and 342 may be in the range of 0.02-0.04; for example, 0.030±0.001. The height of the third and fourth lips 341 and 342 may be less than a height of the second plate 320. A ratio of the height of the third and fourth lips 341 and 342 to height of the second plate 320 may be in the range of 0.3-0.5; for example, 0.406±0.013.

The length of the at least one opening 311 may be less than the length of the first plate 310. A ratio of the length of the at least one opening 311 to the length of the first plate 310 may be in the range of 0.05-0.10; for example, 0.068±0.001. The at least one opening 311 may be an elongated slit such that the width of the at least one opening 311 may be less than the length of the at least one opening 311. The ratio of the width of the at least one opening 311 to the length of the at least one opening 311 may be in the range of 0.05-0.15; for example, 0.093±0.001.

The respective ratios of the lengths, widths, and heights of the first plate 310, second plate 320, third plate 330, first and second lips 351 and 352, third and fourth lips 341 and 342, and openings 311 are not limited to the exemplary measurements disclosed herein. These respective ratios may be used for an adapter bracket 300 that is configured to engage with a longitudinal side of the troffer housing 20, like the adapter brackets 300 shown in FIGS. 1B and 4B. These respective ratios may also be used for an adapter bracket 300 that is configured to engage with a lateral or widthwise side of the troffer housing 20, like the adapter brackets 300 shown in FIGS. 1A and 4A.

Hereinafter, other embodiments of the adapter bracket will be described with emphasis on the differences from the embodiment of FIGS. 5A-5F. Hereinafter, unless there is particular explanation in the following embodiments, the embodiments are to be considered as being identical to the embodiment of FIGS. 5A-5B.

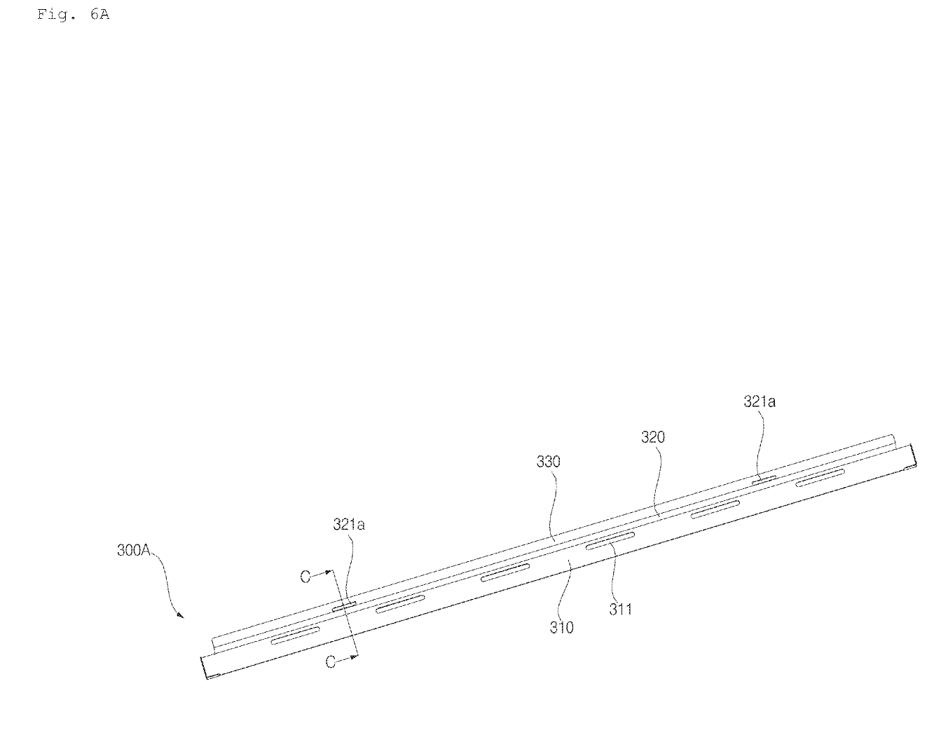

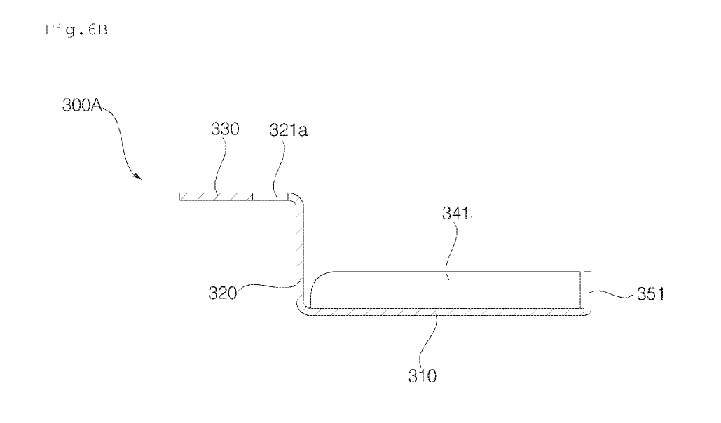

FIG. 6A is a perspective view of an adapter bracket 300A according to an embodiment, and FIG. 6B is a cross-sectional view of the adapter bracket 300A, which is taken along line C-C of FIG. 6A. Referring to FIGS. 6A and 6B, the adapter bracket 300A may be different from the embodiment shown in FIGS. 5A to 5D in its placement of slots 321a. The slots 321a in the adapter bracket 300A may be holes formed through the third plate 330, and may be engaged with the hangers 160 and/or the latches 170 of the lighting assembly 100. The slots 321 may not be partially formed in the second plate 320, and instead may be provided in only the third plate 330. The slots 321a may be positioned so as not to be aligned with the openings 311 in order to maintain the rigidity of the adapter bracket 300A. Even when the slots 321a are formed only in the third plate 330, there may be no problem in the installation of the lighting assembly 100 into the troffer housing 20.

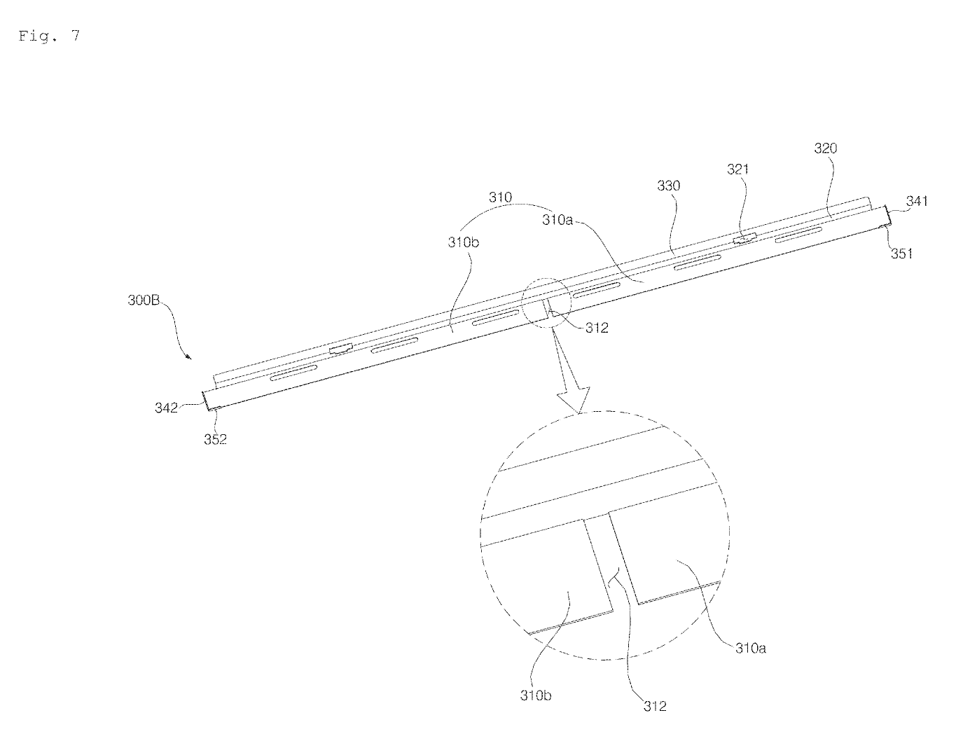

FIG. 7 is a perspective view of an adapter bracket 300B according to an embodiment. Referring to FIG. 7, the adapter bracket 300B may be different from the embodiments shown in FIGS. 5A-5D in that a first plate 310 may be divided into two segments. This configuration, in which a first plate 310 is divided into two segments, may provide another new embodiment through combination with the embodiment shown in FIGS. 6A and 6B, such that a first plate 310 may be divided into two segments while slots 321 may be provided only in a third plate 330.

The first plate 310 may include a first horizontal part or a first surface 310a, a second horizontal part or a second surface 310b, and a segregation slot, a segregation space, or notch 312 separating the first and second surfaces 310a and 310b from each other.

The first surface 310a and the second surface 310b may be provided so as to be spaced apart from each other in the longitudinal direction. The notch 312 may be formed between the first surface 310a and the second surface 310b so as to separate them from each other.

The notch 312 may be formed by cutting at least part of the first plate 310. The notch 312 may be formed by linearly cutting the first plate 310 in the width direction. The notch 312 may have the same length as a width of the first plate 310. The first surface 310a and the second surface 310b may be connected to each other in the state of being spaced apart from each other. That is, the first surface 310a and the second surface 310 may both be connected to a second plate 320, but may not contact each other.

The first surface 310a may be connected to one of two first lips 351 and 352 and one of two third and fourth lips 341 and 342. The first surface 310a may be connected to the first lip 351 and the third lip 341, while a first side of the first surface 310a may be connected to the second plate 320.

The second surface 310b may be connected to one of the two first and second lips 351 and 352 and one of the two third and fourth lips 341 and 342. The second surface 310b may be connected to the second lip 352 and the fourth lip 342. A first side of the second surface 310b may be connected to the second plate 320.

The first surface 310a and the second surface 310b may have the same length or different lengths. In the case where the first plate 310 is divided into the first surface 310a and the second surface 310b, the troffer housing 20 and a portion of the lighting assembly 100 may be accommodated while reducing manufacturing costs and maintaining the rigidity of the adapter bracket 300B.

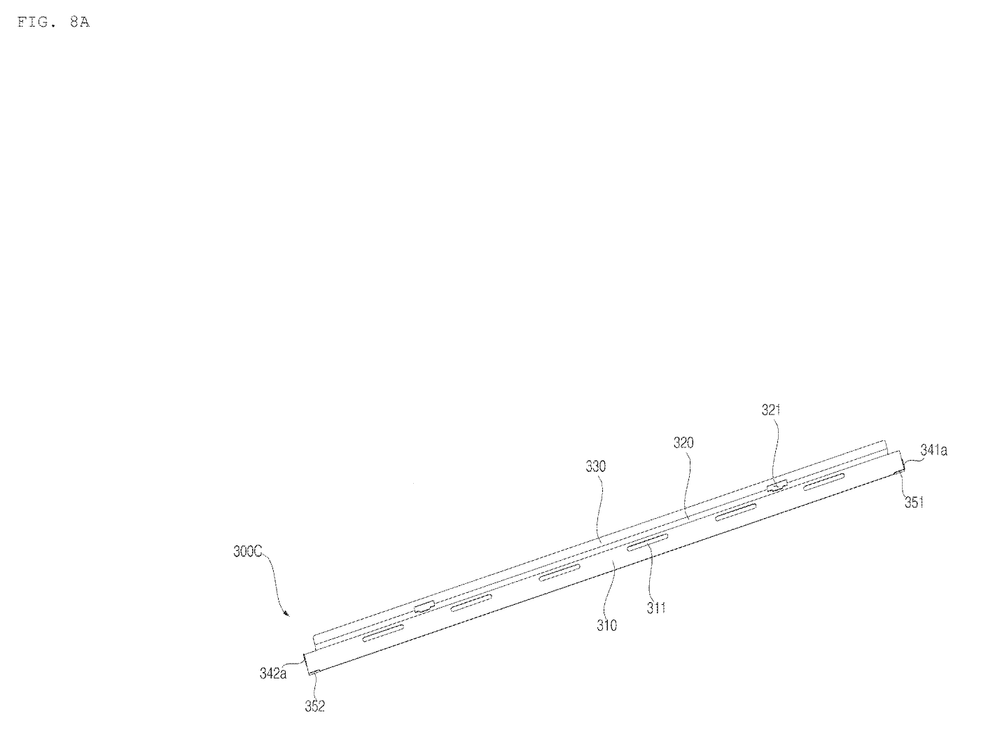

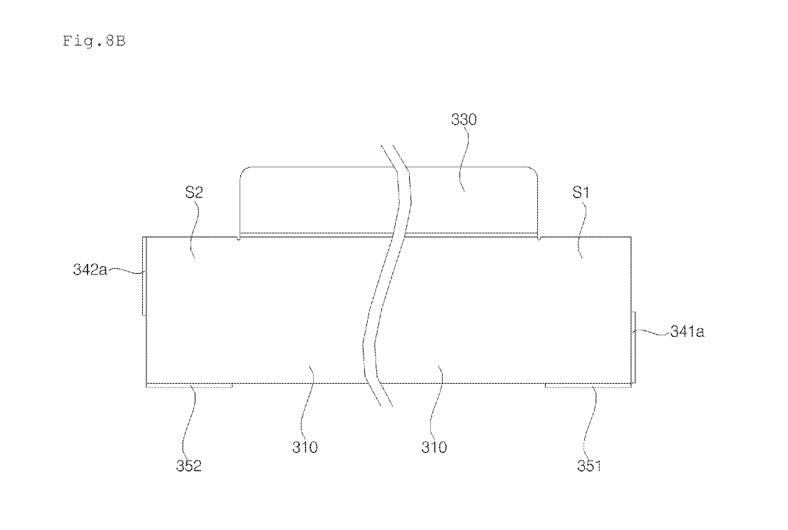

FIG. 8A is a perspective view of an adapter bracket 300C according to an embodiment, and FIG. 8B is a plan view schematically illustrating the adapter bracket 300C shown in FIG. 8A. Referring to FIGS. 8A and 8B, the adapter bracket 300C may be different from the embodiments shown in FIGS. 5A to 7 in the placement of third and fourth lips 341a and 342a. The construction of the third and fourth lips 341a and 342a according to the embodiment shown in FIG. 8 may provide another new embodiment through combination with the embodiment shown in FIG. 6 or 7.

Each of the third and fourth lips 341a and 342a may have a length smaller than the width of the first plate 310. The third and fourth lips 341a and 342a may be provided at opposite sides in the width direction. The third and fourth lips 341a and 342a may be provided so as not to overlap each other in the longitudinal direction. That is, the third and fourth lips 341a and 342a may not face each other, even though they are provided on opposite ends of the first plate 310.

As an example, the third lip 341a may be provided to the left in the width direction so as to be closer to the second side of the first plate 310 than the first side of the first plate 310, whereas the fourth lip 342a may be provided to the right in the width direction so as to be closer to the first side of the first plate 310 than the second side of the first plate 310. Alternatively, the fourth lip 342a may be provided to the left in the width direction so as to be closer to the second side of the first plate 310 than the first side of the first plate 310, whereas the third lip 341a may be provided to the right in the width direction so as to be closer to the first side of the first plate 310 than the second side of the first plate 310. Since the third and fourth lips 341a and 342a may have a length smaller than the width of the first plate 310, manufacturing costs of the adapter bracket 300C may be reduced while a portion of the troffer housing 20 may be secured and accommodated in a stable manner.

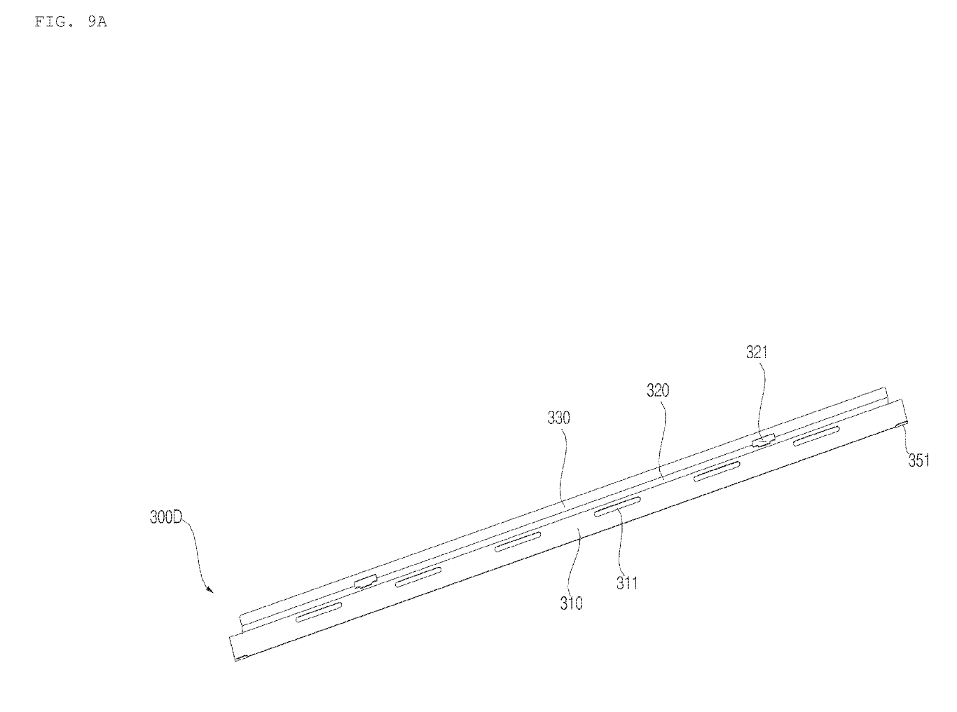

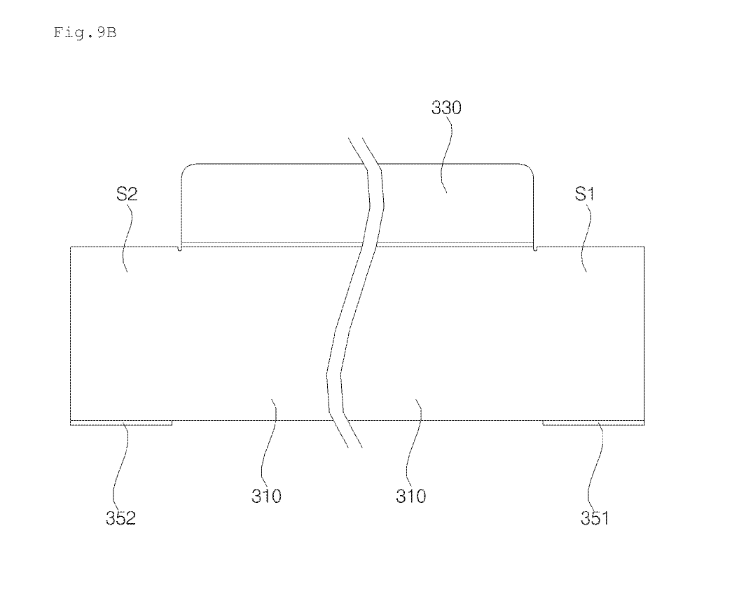

FIG. 9A is a perspective view of an adapter bracket 300D according to an embodiment, and FIG. 9B is a plan view schematically illustrating the adapter bracket 300D shown in FIG. 9A. Referring to FIGS. 9A and 9B, the adapter bracket 300D may be different from the embodiment of FIG. 5 or 6 in that cross vertical parts or third and fourth lips 341 and 342 may be omitted. The embodiment shown in FIGS. 9A and 9B may provide another new embodiment through combination with the embodiments shown in FIGS. 6-8B. In the embodiment shown in FIGS. 9A and 9B, the third and fourth lips 341 and 342 may be omitted, and two parallel vertical parts or first and second lips 351 and 352 may define a space that accommodates and/or constricts a portion of the troffer housing 20, together with the first plate 310 and the second plate 320.

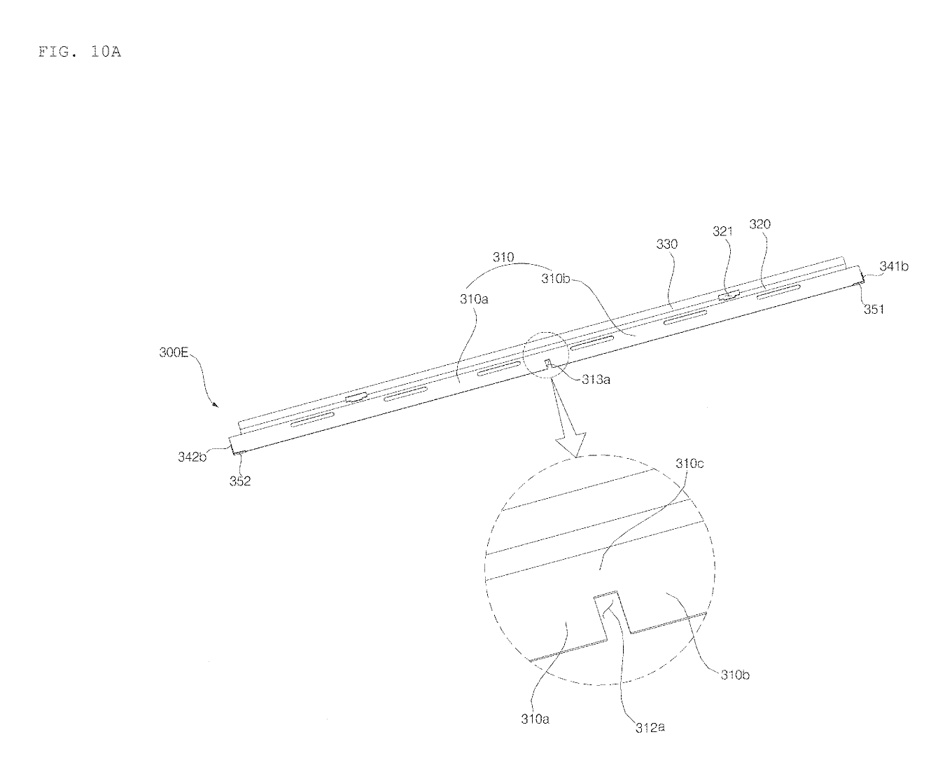

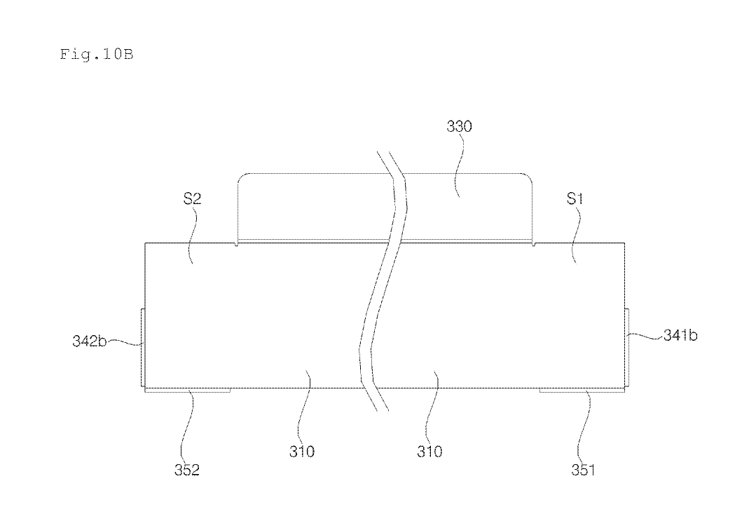

FIG. 10A is a perspective view of an adapter bracket 300E according to an embodiment, and FIG. 10B is a plan view schematically illustrating the adapter bracket 300E shown in FIG. 10A. Referring to FIGS. 10A and 10B, the adapter bracket 300E may be different from the embodiment shown in FIG. 7 from the aspect of a segregation slot, a segregation space, or notch 312a and cross vertical parts or third and fourth lips 341b and 342b. The embodiment shown in FIGS. 10A and 10B may provide another new embodiment through combination with the embodiment of FIGS. 6A and 6B and 8A-9B.

The notch 312a may be formed by cutting a portion of a first plate 310, and may have a length smaller than a width of the first plate 310 such that the first plate 310 is not completely divided into two plates. The notch 312a may extend in a width direction of the adapter bracket 300E. The notch 312a may extend from a center of the first plate 310 to a second side, or a side that is farther away from a first side where a second plate 320 extends from the first plate 310.

The first plate 310 may include first and second surfaces 310a and 310b, and may further include a third surface 310c connecting the first surface 310a to the second surface 310b. The third surface 310c may be positioned so as to overlap with the notch 312a. That is, the first surface 310a and the second surface 310b may be connected to each other via the third surface 310c, which is provided between the notch 312a and the first side of the first plate 310.

Each of the third and fourth lips 341b and 342b may have a length smaller than a width of the first plate 310. The third and fourth lips 341b and 342b may be provided at positions that deviate in the same direction in the width direction. The third and fourth lips 341b and 342b may overlap each other, or face each other, in the longitudinal direction. As an example, the third lip 341b may be provided to the left in the width direction so as to be close to the second side of the first plate 310, and the fourth lip 342b may also be provided to the left in the width direction so as to be close to the second side of the first plate 310.

The notch 312a may have a length corresponding to that of the third and fourth lips 341b and 342b. The notch 312a may be positioned at a side of the first plate 310 at which the third lip 341b and the fourth lip 342b are positioned, in the width direction of the first plate 310. That is, third and fourth lips 341b and 342b may face each other, and the notch 312a may be provided in the first plate 310 between the third and fourth lips 341 and 342. Therefore, since the notch 312a may not be formed throughout the entire first plate 310 in the width direction, manufacturing costs may be reduced while rigidity is maintained.

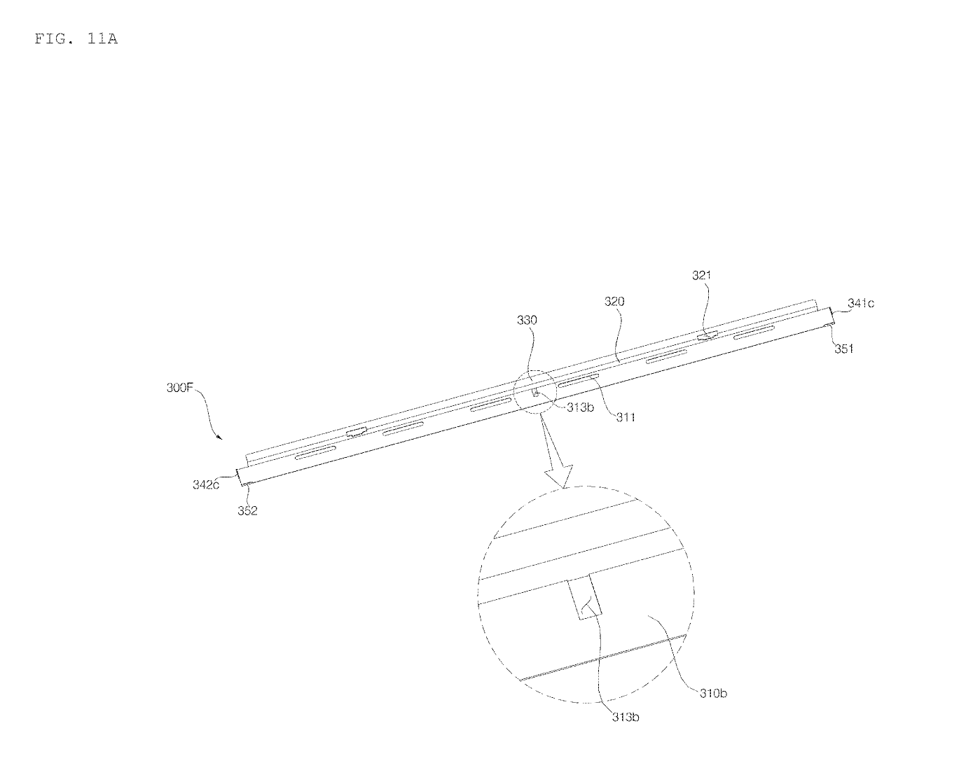

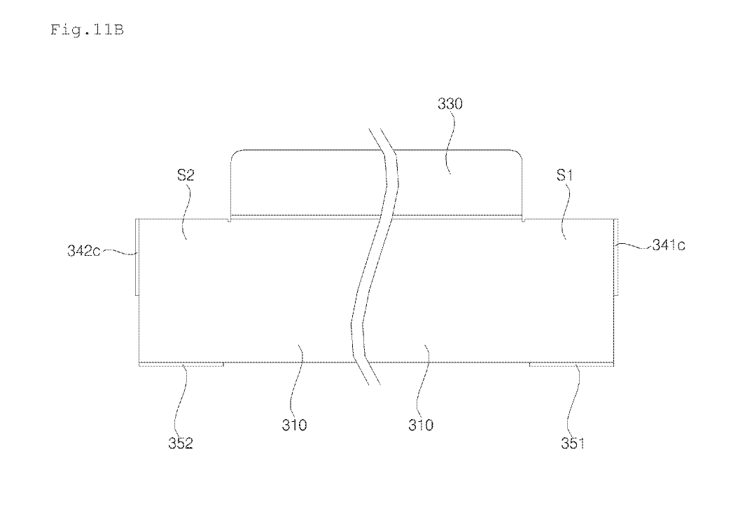

FIG. 11A is a perspective view of an adapter bracket 300F according to an embodiment, and FIG. 11B is a plan view schematically illustrating the adapter bracket 300F shown in FIG. 11B. Referring to FIGS. 11A and 11B, the adapter bracket 300F may be different from the embodiment shown in FIGS. 10A and 10B in the placement of a segregation slot, a segregation space, or notch 312b and third and fourth lips 341c and 342c. The embodiment shown in FIGS. 11A and 11B may provide another new embodiment through combination with the embodiments of FIGS. 6A and 6B and 8A-9B.

The notch 312b may be formed in a portion of a first plate 310, and may have a length smaller than a width of the first plate 310. The notch 312b may extend in the width direction of the adapter bracket 300F. The notch 312b may be formed from a center of the first plate 310 to a first side, toward a second plate 320.

Each of the third and fourth lips 341c and 342c may have a length smaller than the width of the first plate 310. The third and fourth lips 341c and 342c may be provided at the same side of the first plate 310 in the width direction. The third and fourth lips 341c and 342c may be provided so as to overlap or face each other in the longitudinal direction. As an example, the third lip 341c may be provided to the right in the width direction so as to be closer to the first side of the first plate 310 than a second side of the first plate 310 that does not connect to the second plate 320, and the fourth lip 342c may also be provided to the right in the width direction so as to be closer to the first side of the first plate 310 than the second side of the first plate 310.

The notch 312b may have a length corresponding to the length of each of the third and fourth lips 341c and 342c. The notch 312b may be positioned at the side of the first plate 310 at which the third and fourth lips 341c and 342c are positioned. That is, third and fourth lips 341c and 342c may face each other, and the notch 312b may be provided on the first plate 310 between the third and fourth lips 341c and 342c. Since the notch 312b may not be formed completely through the first plate 310 in the width direction, manufacturing costs may be reduced while rigidity is maintained.

As is apparent from the above description, according to an embodiment, since two parallel vertical parts or lips may be connected to portions of a horizontal part or a first plate without overlapping a side part or a second plate, a portion of the troffer housing may be secured and accommodated in a stable manner while manufacturing costs are reduced.

According to an embodiment, since two cross vertical parts or lips may be connected to portions of a horizontal part or a first plate without overlapping a side part or a second plate, a portion of the troffer housing may be secured and accommodated in a stable manner while manufacturing costs are reduced.

According to an embodiment, since a horizontal part or a first plate may be divided into a first horizontal part or a first surface and a second horizontal part or a second surface, a space that accommodates a troffer housing and a space that accommodates a portion of the lighting assembly 100 may be provided, while rigidity of the adapter bracket is maintained.

According to an embodiment, since two cross vertical parts or lips may not be aligned with each other and have a length smaller than a width of a horizontal part or a first plate, a portion of the troffer housing may be secured and accommodated in a stable manner while manufacturing costs are reduced.

According to an embodiment, since a lighting assembly may be rotatably coupled at one or a first end thereof to an adapter bracket, a worker's electrical wiring work and maintenance may be made easy and convenient.

According to an embodiment, since a lighting assembly may be hung at one or a first end thereof on an adapter bracket by a hanger and may be held at another or a second end thereof on the adapter bracket by a rotatable latch, attachment and detachment of the lighting assembly by rotation of the latch may be made easy and convenient.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and are not to be interpreted in an idealized or overly formal sense unless expressly so defined herein.

In the drawings, the thickness or size of each layer is exaggerated, omitted, or schematically illustrated for convenience of description and clarity. Also, the size or area of each constituent element does not entirely reflect the actual size thereof.

Therefore, embodiments disclosed herein have been made in view of the above problems, and embodiments disclosed herein may provide an adapter bracket and a troffer mounting system including the same, which may be able to facilitate replacement, maintenance, and installation of a lighting assembly and to reduce manufacturing costs.

The above and other objects of embodiments disclosed herein can be accomplished by a provision of an adapter bracket that may include a horizontal part or a first plate provided between a T-bar of a ceiling system and a troffer housing so as to be placed on the T-bar and to extend longitudinally; a side part or second plate connected to a first side of the horizontal part and having a length smaller than a length of the horizontal part, the side part extending upward; two parallel vertical parts or two lips connected to a second side of the horizontal part that is opposite the first side, the two parallel vertical parts extending upward; and a latch part or third plate connected to a side of the side part so as to engage with a latch, wherein the two parallel vertical parts may not overlap or face the side part in a width direction.

Although the embodiments disclosed herein have been disclosed for illustrative purposes, those skilled in the art will appreciate that various modifications, additions and substitutions are possible, without departing from the scope and spirit of the invention as disclosed in the accompanying claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An adapter bracket including:
first and second plates extending in a first direction such that the first and second plates are parallel to each other and have first and second lengths, respectively, each of the first and second plates having first and second sides extending in the first direction;
a coupling plate coupling the first and second plates at the second sides of the first and second plates such that the first and second plates extend in the first direction on separate planes, the coupling plate having a third length smaller than the first length such that the first plate includes first and second sections that extend beyond opposite sides of the coupling plate in the first direction, wherein the first section has a fourth length and the second section has a fifth length;
a first lip provided at the first section on the first side of the first plate, the first lip having a sixth length, that is less than or equal to the fourth length; and
a second lip provided at the second section on the first side of the first plate in the second section, the second lip having a seventh length, that is less than or equal to the fifth length.

2. The adapter bracket according to claim 1, further including third and fourth lips, wherein the first plate has third and fourth sides that extend in a second direction different than the first direction and are at opposite sides of the first plate, and wherein the third lip is provided on the third side of the first plate and the fourth lip is provided on the fourth side of the first plate.

3. The adapter bracket according to claim 2, wherein at least one of the third lip or the fourth lip has a width in the second direction, the width being less than or equal to the first width.

4. The adapter bracket according to claim 1, wherein the coupling plate has a first height extending in a third direction that is different than the first and second directions, and the first and second lips have second and third heights extending in the third direction, wherein the second and third heights are smaller than the first height.

5. The adapter bracket according to claim 2, wherein the coupling plate has a first height extending in a third direction that is different than the first and second directions, and the third and fourth lips have second and third heights extending in the third direction, wherein the second and third heights are smaller than the first height.

6. The adapter bracket according to claim 1, further including a notch in the first plate.

7. The adapter bracket according to claim 6, wherein the notch completely separates the first plate into a first surface and a second surface such that the first surface does not contact the second surface, and wherein the notch, the first surface, and the second surface all contact the coupling plate.

8. The adapter bracket according to claim 2, wherein the third and fourth lips face each other.

9. The adapter bracket according to claim 2, wherein the third and fourth lips do not face each other such that the third lip faces an opening on the fourth side of the first plate, and the fourth lip faces an opening on the third side of the first plate.

10. The adapter bracket according to claim 1, further including a plurality of openings provided in the first plate.

11. The adapter bracket according to claim 1, further including at least one slot provided on an edge where the second side of the second plate connects to the coupling plate such that the slot is partially provided in the coupling plate and the second plate, wherein the at least one slot is configured to engage with a latch or a hanger.

12. The adapter bracket according to claim 1, wherein the first plate is configured to be placed between a T-bar of a ceiling and an existing troffer housing.

13. The adapter bracket according to claim 12, wherein at least one slot is provided on an edge where the second side of the second plate connects to the coupling plate such that the slot is partially provided in the coupling plate and the second plate, wherein the at least one slot is configured to engage with a latch or a hanger of lighting assembly or a lighting fixture.

14. An adapter bracket including:
first and second plates extending in a first direction such that the first and second plates are parallel to each other and have first and second lengths, respectively, each of the first and second plates having first and second sides extending in the first direction;
a coupling plate coupling the first and second plates at the second sides of the first and second plates such that the first and second plates extend in the first direction on separate planes, the coupling plate having a third length smaller than the first length such that the first plate includes first and second sections that extend beyond opposite sides of the coupling plate in the first direction, wherein the first section has a fourth length and the second section has a fifth length;
first and second lips, wherein the first plate has third and fourth sides that extend in a second direction different than the first direction and are at opposite sides of the first plate, and wherein the first lip is provided on the third side of the first plate and the second lip is provided on the fourth side of the first plate.

15. A troffer mounting system, including:
a troffer housing,
a lighting fixture, and,
a pair of adapter brackets, each adapter bracket including:
a first quadrilateral surface having first and second lengthwise sides and first and second widthwise sides, wherein the first and second lengthwise sides are longer than the first and second widthwise sides and wherein the troffer housing rests on a portion of the first quadrilateral surface;
a second quadrilateral surface that is parallel to the first quadrilateral surface and having first and second lengthwise sides and first and second widthwise sides;
a third quadrilateral surface having first and second lengthwise sides and first and second widthwise sides, wherein the first and second lengthwise sides of the third quadrilateral surface are shorter than the first and second lengthwise sides of the first quadrilateral surface, wherein the third quadrilateral surface connects the second lengthwise side of the first quadrilateral surface to the first lengthwise side of the third quadrilateral surface such that a location on which the third quadrilateral surface extends from the first quadrilateral surface defines an inner section of the first quadrilateral surface that is adjacent to and contacts the third quadrilateral surface, wherein the first quadrilateral surface does not face the second quadrilateral surface; and wherein at least one slot is formed in the first lengthwise side of the second quadrilateral surface and extends into the second lengthwise side of the third quadrilateral surface and is configured to receive a hanger or latch of the lighting fixture;
fourth and fifth quadrilateral surfaces parallel to the third quadrilateral surface and each having first and second lengthwise sides and first and second widthwise sides, wherein a sum of the first lengthwise sides of the fourth and fifth quadrilateral surfaces is less than or equal to a difference in length between the first lengthwise side of the first quadrilateral surface and the first lengthwise side of the third quadrilateral surface, and wherein the first lengthwise sides of the fourth and fifth quadrilateral surfaces extend from the first lengthwise side of the first quadrilateral surface at a location that is not in the inner section of the first quadrilateral surface.

16. The troffer mounting system according to claim 15, wherein the adapter bracket further includes a sixth quadrilateral surface extending from the first widthwise side of the first quadrilateral surface, and a seventh quadrilateral surface extending from the second widthwise side of the first quadrilateral surface, such that a space that accommodates the troffer housing may be defined by the first, third, fourth, fifth, sixth, and seventh quadrilateral surfaces, wherein the space is partially enclosed on sides of the space that are defined by the first, third, fourth, fifth, sixth, and seventh quadrilateral surfaces.

17. The troffer mounting system according to claim 15, wherein the adapter bracket further includes a plurality of openings provided in the first quadrilateral surface, and a notch that extends from a center of the first quadrilateral surface to at least one of the lengthwise sides of the first quadrilateral surface.

18. The troffer mounting system according to claim 16, wherein the fourth, fifth, sixth, and seventh quadrilateral surfaces each have first widthwise sides and second width wide sides that are shorter than first widthwise sides and second widthwise sides of the third quadrilateral surface.
